(19) United States
(12) Patent Application Publication
(10) Pub. No.: US 2013/0180810 A1
(43) Pub. Date: Jul. 18, 2013

(54) Disc Brake for a Motor Vehicle and Brake Pad Assembly Therefor

(71) Applicants: Christian Schroeter, Sinzig (DE); Frank Madzgalla, Koblenz (DE); Manfred Haupt, Hohr-Grenzhausen (DE); Marco Becker, Oberdurenbach (DE); Frank Laubcnthal, Wirfus (DE); Markus Mallmann, Pfalzfeld (DE)

(72) Inventors: Christian Schroeter, Sinzig (DE); Frank Madzgalla, Koblenz (DE); Manfred Haupt, Hohr-Grenzhausen (DE); Marco Becker, Oberdurenbach (DE); Frank Laubcnthal, Wirfus (DE); Markus Mallmann, Pfalzfeld (DE)

(73) Assignee: Lucas Automotive GmbH, Koblenz (DE)

(21) Appl. No.: 13/518,526

(22) PCT Filed: Dec. 23, 2010
(86) PCT No.: PCT/EP2010/007920

§ 371 Date: Sep. 18, 2012

(30) Foreign Application Priority Data
Dec. 23, 2009 (DE) 10 2009 060 204.6

(51) Int. Cl. F16D 65/54; B60T 1/06

(52) U.S. Cl. CPC F16D 65/543; B60T 1/065
USPC 188/71.8

(57) ABSTRACT

A disc brake for a motor vehicle includes a spring arrangement mounted on at least one mounting tongue of a brake pad carrier. The spring arrangement provides a predetermined spring travel, which is dimensioned such that a movement of the brake pad carrier for actuating the brake is permitted without brake pad wear compensation and such that when using up the predetermined spring travel the brake pad arrangement contacts the spring arrangement for brake pad wear compensation and moves the latter within a brake pad arrangement guide in order to compensate brake pad wear.

### CROSS-REFERENCE TO RELATED APPLICATIONS

This application is a national stage of International Application No. PCT/EP2010/0079290 filed Dec. 23, 2010, the disclosures of which are incorporated herein by reference in entirety, and which claimed priority to German Patent Application No. DE 10 2009 060 204.6 filed Dec. 23, 2009, the disclosures of which are incorporated herein by reference in entirety.

### BACKGROUND OF THE INVENTION

The present invention relates to a disc brake for a motor vehicle, comprising a guide, in which at least one brake pad arrangement is moveably guided for achieving a brake effect, wherein the brake pad arrangement has a brake pad carrier, on which a vehicle brake pad is mounted, which can be brought into interaction with a brake disc for achieving a brake effect, wherein the brake pad carrier has at least one mounting tongue and wherein the guide has at least one receiving region, wherein the mounting tongue is receivable in the at least one receiving region such that it is guided in an actuation direction, wherein a spring arrangement is mounted on the at least one mounting tongue, by means of which spring arrangement a return force due to an elastic deformation caused by a deflection of the brake pad arrangement in order to achieve a brake effect can be applied thereon.

Disc brakes of this kind are known from the prior art. Thus, for example, the document DE 196 50 592 A1 shows a disc brake of this kind, in which a brake pad arrangement with a plate-shaped brake pad carrier and a brake pad arranged thereon is held in the guide of the disc brake via a spring arrangement. The spring arrangement is elastically deformed on each movement of the brake pad arrangement. The spring arrangement is held on a catch web of the guide. In the event of wear, i.e. when the brake pad shows wear phenomena owing to frequent brake actuations, the spring arrangement is likewise elastically deformed in the course of wear compensation. However, this has the disadvantage that the return forces during brake actuation may change due to wear as compared with the design state when free from wear.

The document U.S. Pat. No. 5,284,228 shows a similar arrangement. In this document too, a spring arrangement is mounted on the housing of the disc brake and presses against the brake pad carrier.

The document US 2004/0195056 A1 shows a brake pad arrangement in which a spring arrangement is mounted on the brake pad carrier and supported on the housing of the disc brake. In this arrangement too, the spring bias increases with increasing wear and corresponding wear adjustment. The document DE 102 38 734 A1 shows a disc brake with a brake pad spring which requires an additional brake pad guide element. The spring is of complicated design and relatively large size. The spring shackles required to apply the spring forces are relatively protruding. If these spring shackles are designed smaller, the functioning suffers as a result.

The same applies to the prior art according to U.S. Pat. No. 7,086,506 B2. The spring elements mounted on the brake pad carrier in this document are likewise of complicated design and have a relatively large space requirement.

### BRIEF SUMMARY OF THE INVENTION

By contrast, a feature of the present invention is to provide a disc brake and a brake pad arrangement therefor which has a defined functioning while being of relatively simple construction. In particular, the disc brake according to the invention is aimed at achieving a clear distinction between normal brake actuation and wear compensation.

This feature is achieved by a disc brake of the kind described at the outset, in which it is provided that the spring arrangement has spring support sections, by means of which the spring arrangement is supported in a biased state in the receiving region, and that the spring arrangement provides a predetermined spring travel, which is dimensioned such that a movement of the brake pad carrier for actuating the brake is permitted without brake pad wear compensation and such that when using up the predetermined spring travel the brake pad arrangement contacts the spring arrangement for brake pad wear compensation and moves the latter within the guide in order to compensate brake pad wear.

The provides that a normal brake actuation takes place within the predetermined spring travel, i.e. in a normal brake actuation up to full braking, the predetermined spring travel is not used up. Only when wear has occurred on the brake pad and requires a pad wear compensation, i.e. when the brake pad carrier in a disc brake housing or brake carrier of the disc brake, depending on the design as floating-caliper brake or fixed-caliper brake, is to be moved permanently towards the brake disc, does the brake pad arrangement come into contact with the spring arrangement, whereby no further spring travel is then available. If in this state the actuation force for moving the brake pad arrangement increases further, the brake pad arrangement is permanently moved in the guide of the disc brake together with the spring arrangement until the wear which has occurred on the brake pad is compensated by an advancing movement.

By providing a predetermined spring travel and the subsequent form-fitting or planar contact of brake pad arrangement and spring arrangement, the invention therefore creates a clear distinction between a normal brake actuation without pad wear compensation, i.e. without advancing, and a brake actuation with pad wear compensation. As a result, the invention achieves a significant advantage over the prior art in which it is frequently not possible to distinguish in a defined manner between the state of the normal brake actuation and the state of the brake actuation with pad wear compensation.

A development of the invention provides that the spring arrangement embraces the mounting tongue, the spring arrangement having, on the side facing the brake pad, at least one abutment section which is spaced by the predetermined spring travel from the mounting tongue. By providing an abutment section which is spaced by the predetermined spring travel from the mounting tongue, the movement play of the brake pad arrangement can be clearly defined.

A development of the invention provides that at least one spring means is provided between the brake pad and the side of the spring arrangement facing the brake pad. Alternatively to this, it may be provided that at least one spring means is provided between the abutment section and the side of the spring arrangement facing away from the brake pad.

A variant embodiment of the invention provides that the at least one spring means has at least one spring shackle which is formed on the spring arrangement, in particular on the abutment section, and bears resiliently against the mounting tongue. It is thus possible for the at least one spring shackle to be formed by a protruding spring tab which is formed in one piece on the spring arrangement or fastened in a force-fitting or form-fitting manner thereto. In this case, it may be provided that the spring tab is of V-shaped form. The spring tab can yield resiliently by virtue of the fact that the V-shaped spreading is increased or reduced by compression.

According to the invention, it may further be provided that the mounting tongue is provided, on its side facing the brake pad, with a spring holding means, in particular with a recess, on which means is mounted a separate spring element which is supported against the mounting tongue and against the spring arrangement. Thus, for example, a blind-hole bore can be provided in the region of the mounting tongue, which bore is provided for receiving spring means. In particular, it is in this case possible for the at least one spring means to be formed by a compression spring or a leaf spring which passes through the mounting tongue at least partially. Alternatively to a blind-hole bore, the mounting tongue can also be traversed completely in this region, a bolt-like spring element being inserted into the opening and spreading out on the side facing the brake pad, so as to form two or more spring tabs which are elastically deformable.

According to a preferred embodiment of the invention, the spring arrangement can be received in a form-fitting or force-fitting manner in recesses which are formed on the at least one mounting tongue. Thus, for example, it is possible to form, on the end face of the mounting tongue oriented orthogonally to the brake pad side, corresponding recesses in the mounting tongue which are adapted to the cross-sectional profile of the spring arrangement in this region, so that the spring arrangement can be inserted or pushed in with corresponding sections and then held in a form-fitting or force-fitting manner. The recesses can also extend over neighbouring surfaces running perpendicular to one another or be formed in projections on the mounting tongue.

A variant embodiment which can be produced particularly cost-effectively is obtained, for example, when the spring arrangement is formed from a spring wire. Thus, it is possible for the spring arrangement to be formed by a partially or completely closed spring clip. In this embodiment, the spring clip can therefore be formed as a multiply bent spring wire and wrap around or embrace the mounting tongue accordingly. In this case, it is possible according to the invention for the at least one spring shackle to be formed as a loop-shaped section of the spring clip.

A development of the invention provides that the spring arrangement has a spring back which bears resiliently against the side of the mounting tongue facing away from the brake pad. This spring back can be of arcuately curved configuration, with its vertex region bearing against the brake pad carrier. The spring back can, however, also be of substantially rectilinear configuration or interrupted.

A development of the invention provides that the spring support sections are attached to the spring back and spread out resiliently starting from said back. This configuration has the advantage that the spring support sections are already bearing on in the receiving region under spring bias owing to their spreading. For the purpose of mounting, the spring support sections have to be pressed together to reduce the spreading in order to be able to be pushed into the receiving region.

According to the invention, it may further be provided that the spring arrangement has at least one spring tongue which positions the mounting tongue in the spring arrangement in a biased state transversely to the actuation direction. This ensures that the brake pad carrier is positioned and held in a predetermined position via the spring tongue also transversely to the actuation direction. The spring tongue may, for example, have been attached in one piece to the spring arrangement or subsequently fixed thereto.

A development of the invention provides a sensor arrangement which passes through the spring arrangement and the brake pad at least partially, and which is designed to determine the pad wear. By means of the sensor arrangement, it is therefore possible to determine the current wear state or the reaching of a wear level which gives occasion to indicate to the driver the need to carry out maintenance.

The invention in an exemplary embodiment further provides a support element which is fixed on the mounting tongue and against which the spring arrangement is resiliently supported. In this variant embodiment, the mounting tongue is replaced by an opening. At this opening there is provided a bolt with a bolt head which protrudes from the side facing away from the brake pad. The spring element is supported against this bolt head in such a way that it provides the predetermined spring travel.

A development of the invention provides that a filling element, in particular a filling ring, is provided between the spring arrangement and the mounting tongue on the side of the latter facing the brake pad. This filling element ensures that the space between spring arrangement and mounting tongue, which could fill with abraded material in the course of the service life, is sufficiently sealed off, so as to be able to prevent such a filling with abraded material which may possibly impair the functioning.

According to a further configuration of the invention, it may be provided that the spring arrangement is produced from a folded spring metal sheet and embraces the at least one mounting tongue in a cage-like manner, the spring arrangement having at least one fastening arm and at least one transverse clasp, with which the spring arrangement engages in a holding manner on the mounting tongue. Furthermore, it may be provided that the spring arrangement has a catch claw for positioning the spring arrangement on the mounting tongue. The catch claw may also perform a spring function. In this connection, according to a development of the invention it is further possible for the spring arrangement to have at least one clamping extension which serves for clamping the spring arrangement on the mounting tongue. Via the at least one clamping extension, the pad carrier can be held and guided with static friction in the receiving region of the actuation device. The at least one clamping extension can be angled off relative to the rest of the spring arrangement at a suitable angle of up to 90°. The spring arrangement can be designed such that it either pulls or pushes the brake pad carrier back into the predetermined initial position after an elastic deflection due to a brake actuation.

The invention further relates to a brake pad arrangement for a disc brake of the kind described above, wherein the brake pad arrangement has a brake pad carrier, on which a vehicle brake pad is mounted, wherein the brake pad carrier has at least one mounting tongue, wherein the mounting tongue is receivable in at least one receiving region such that it is guided in an actuation direction, wherein a spring arrangement is mounted on the at least one mounting tongue, by means of which spring arrangement a return force due to an elastic deformation caused by a deflection of the brake pad arrangement in order to achieve a brake effect can be applied thereon. In this case, it may be provided that the spring arrangement has spring support sections, by means of which the spring arrangement is supported in a biased state in the receiving region, and that the spring arrangement provides a predetermined spring travel, which is dimensioned such that a movement of the brake pad carrier for actuating the brake is permitted without brake pad wear compensation and such that when using up the predetermined spring travel the brake pad arrangement contacts the spring arrangement for brake pad wear compensation and moves the latter within the guide in order to compensate brake pad wear.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a sectional view through a disc brake with a brake disc and two brake pad arrangements arranged at the sides thereof and guided in a disc brake housing or a brake carrier;

FIG. 2 shows a detail view of a mounting tongue of a brake pad carrier in a front view;

FIG. 3 shows a view corresponding to FIG. 2, but from the other side of the brake pad carrier;

FIG. 4 shows a detail view from FIG. 1 in the rest position;

FIG. 5 shows a detail view corresponding to FIG. 4 in the actuating position without wear compensation;

FIG. 6 shows a combination of brake pad carrier and spring arrangement of the first embodiment of the invention before mounting;

FIG. 7 shows the arrangement according to FIG. 6 during mounting in the disc brake housing or brake carrier;

FIG. 8 shows an illustration corresponding to FIG. 5 for explaining the wear compensation;

FIG. 9 shows a second embodiment of the invention in a sectional view;

FIG. 10a shows a spring arrangement of a third embodiment of the invention;

FIG. 10b shows an embodiment of the invention modified with respect to FIG. 10a;

FIG. 11 shows the third embodiment of the invention in a sectional view;

FIG. 12 shows a spring arrangement of a fourth embodiment of the invention;

FIG. 13 shows the fourth embodiment of the invention in a sectional view;

FIG. 14 shows the spring arrangement of a fifth embodiment of the invention;

FIG. 15 shows the fifth embodiment of the invention in a sectional view;

FIG. 16 shows a spring arrangement of a sixth embodiment of the invention;

FIG. 17 shows the sixth embodiment of the invention in a sectional view;

FIG. 18 shows the spring arrangement of a seventh embodiment of the invention;

FIG. 19 shows the seventh embodiment of the invention in a sectional view;

FIG. 20 shows a spring arrangement of an eighth embodiment of the invention;

FIG. 21 shows the eighth embodiment of the invention in a sectional view;

FIG. 22 shows a spring arrangement of a ninth embodiment of the invention;

FIG. 23 shows the ninth embodiment of the invention in a sectional view.

FIG. 24 shows a partially sectioned side view of a further embodiment of the invention;

FIG. 25 shows the embodiment according to FIG. 24 viewed in the direction of the side facing away from the brake pad;

FIG. 26 shows a view of the embodiment according to FIGS. 24 and 25 viewed in the direction of the side of the mounting tongue facing the brake pad, with the mounting tongue received in the receiving region of the disc brake housing;

FIG. 27 shows a further embodiment of the invention, modified with respect thereto, in a perspective view;

FIG. 28 shows a view of the embodiment according to FIG. 27 from another viewing angle;

FIG. 29 shows a detail view with respect to the embodiment according to FIGS. 27 and 28 in a side view;

FIG. 30 shows a further embodiment of the invention in a perspective partial view;

FIG. 31 shows a plan view of the spring clip from FIG. 30;

FIG. 32 shows a side view with respect to the embodiment of FIGS. 30 and 31;

FIG. 33 shows a perspective view of an installed situation of a disc brake of a further embodiment of the invention;

FIG. 34 shows the detail, denoted by A in FIG. 33, in an enlarged view;

FIG. 35 shows the spring arrangement according to FIG. 34 in a cutaway view;

FIG. 36 shows a sectional view through FIG. 34 along the section plane XZ;

FIG. 37 shows a sectional view along the section plane XY;

FIG. 38 shows a perspective individual-component view of a spring arrangement of a further embodiment according to the present invention;

FIG. 39 shows a front view of this spring arrangement;

FIG. 40 shows a longitudinal sectional view corresponding to the section plane XY;

FIG. 41 shows a view corresponding to FIG. 33 of this embodiment;

FIG. 42 shows an enlarged view of the dashed circled area B in FIG. 41.

### DETAILED DESCRIPTION OF THE INVENTION

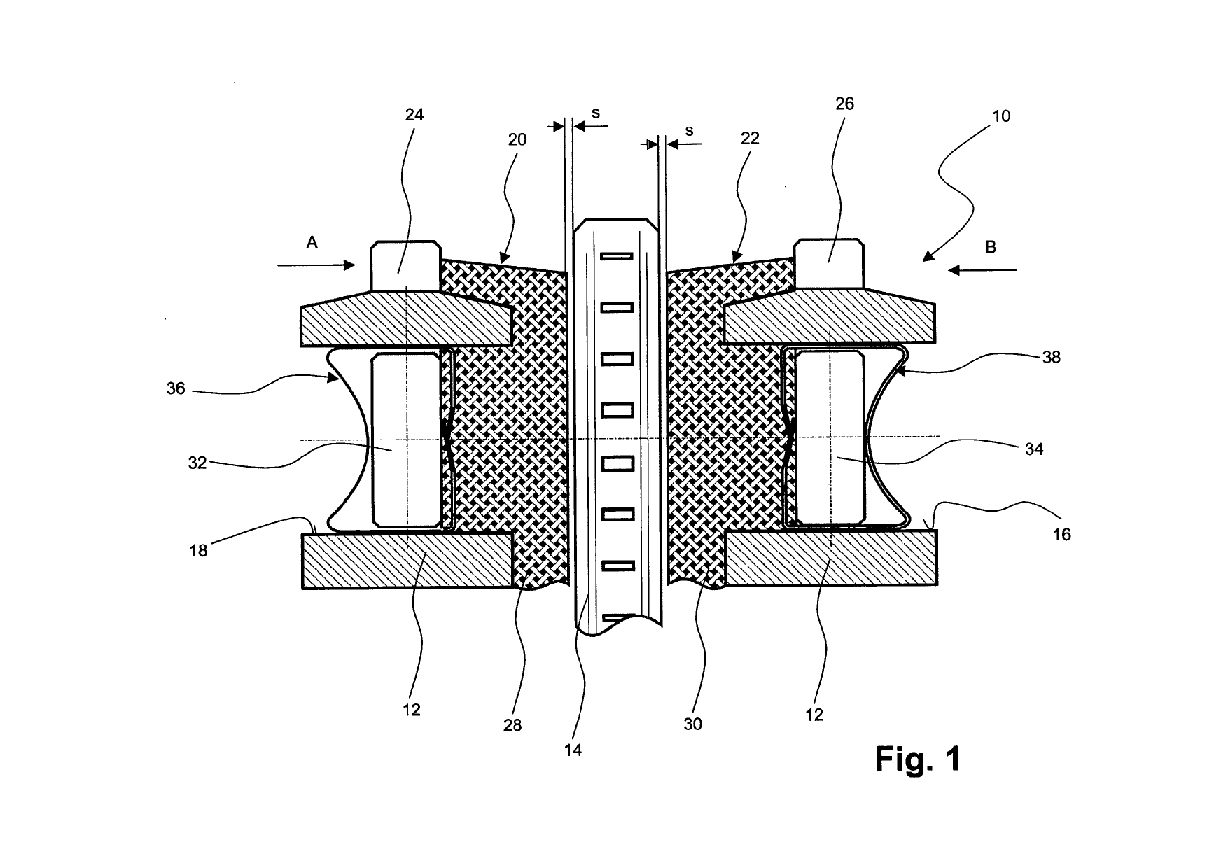

FIG. 1 shows a sectional view through a disc brake 10 according to the present invention. The disc brake 10 comprises a brake carrier (marked with hatching) of a floating-caliper brake 12, which straddles a brake disc 14. The brake disc 14 is connected in a rotationally fixed manner to a wheel to be braked, in the conventional manner.

The brake carrier 12 has two mutually opposite guides with guiding receiving regions 16 and 18. In each of these receiving regions 16 and 18, there is moveably guided a respective brake pad arrangement 20 and 22. The brake pad arrangements 20 and 22 can be moved by application of forces (which is not shown in more detail) in the direction of the arrows A and B towards the brake disc 14, in order to achieve a brake effect. In the process, it is necessary to travel through a clearance s, which ensures that, in the rest position shown, the brake pads do not exert any rest rubbing moments and hence any braking force on the brake disc. To achieve a brake effect, the brake pad arrangements 20 and 22 must be pressed more or less firmly against the brake disc 14.

The brake pad arrangements 20 and 22 each have a brake pad carrier 24 and 26, with a respective brake pad 28 and 30 being mounted on each brake pad carrier 24 and 26. Each brake pad carrier 24 and 26 has a respective mounting tongue 32 and 34, one on either side. The mounting tongues 32 and 34 are displaceably received in the receiving region 16 and 18 for guidance. Mounted on each mounting tongue 32 and 34 is a respective sigma (Σ)-shaped spring arrangement 36 and 38. Hereinbelow, only the spring arrangement 36 is described, with the spring arrangement 38 being formed in the same manner.

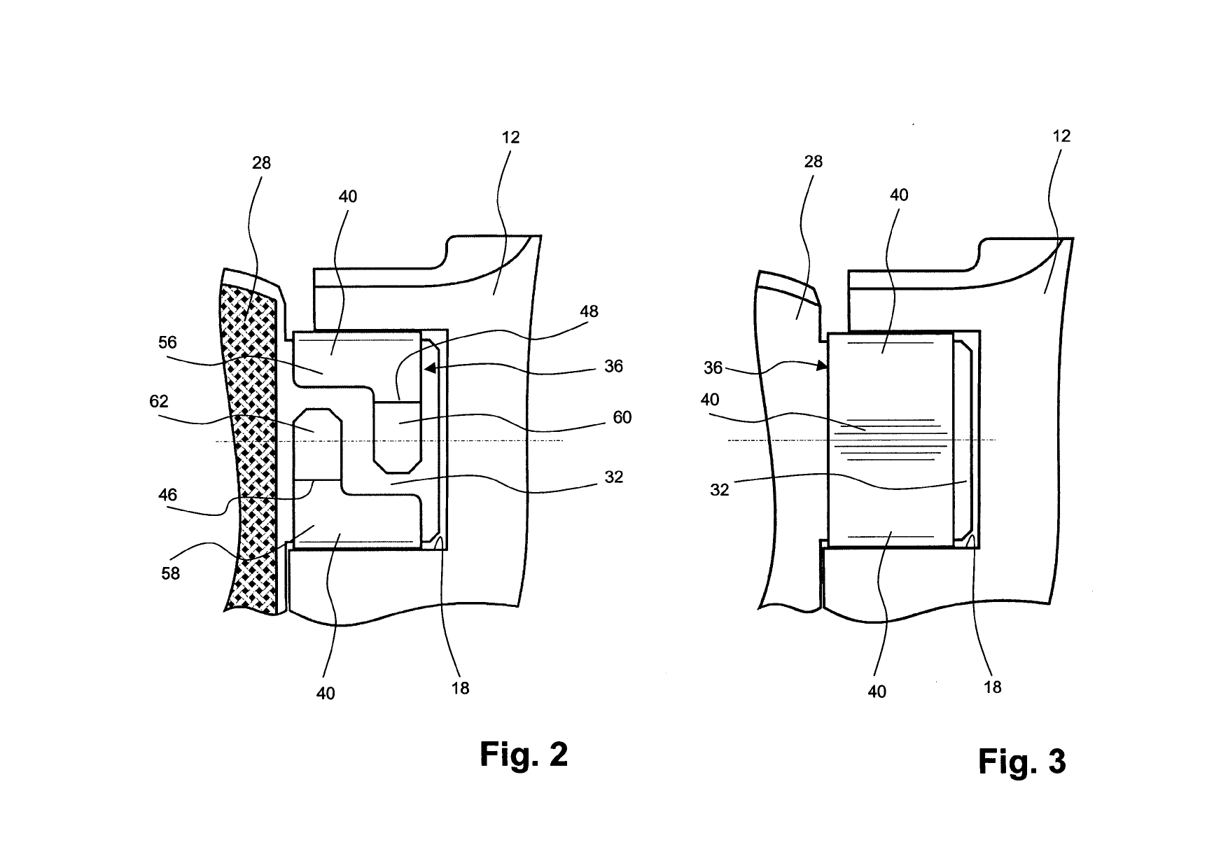

In FIG. 2 there can be seen, in a partial view of the brake pad 28, that the spring element 36 is mounted on the mounting tongue 32, with the latter having a band-like body 40 by which it embraces the mounting tongue 32. FIG. 3 shows the view from the opposite side, revealing that the band-like section 40 runs all the way round the mounting tongue 32 on this side. The spring arrangement 36 then ends in two tab-shaped sections 60 and 62 which laterally overlap one another in the embodiment shown. These two spring tabs 60 and 62 are bent off at a respective point 46 and 48 towards the mounting tongue 32 and bear with their free ends resiliently against the mounting tongue 32. It can further be seen that the mounting tongue 32 is received in the receiving region 18 of the brake carrier 12.

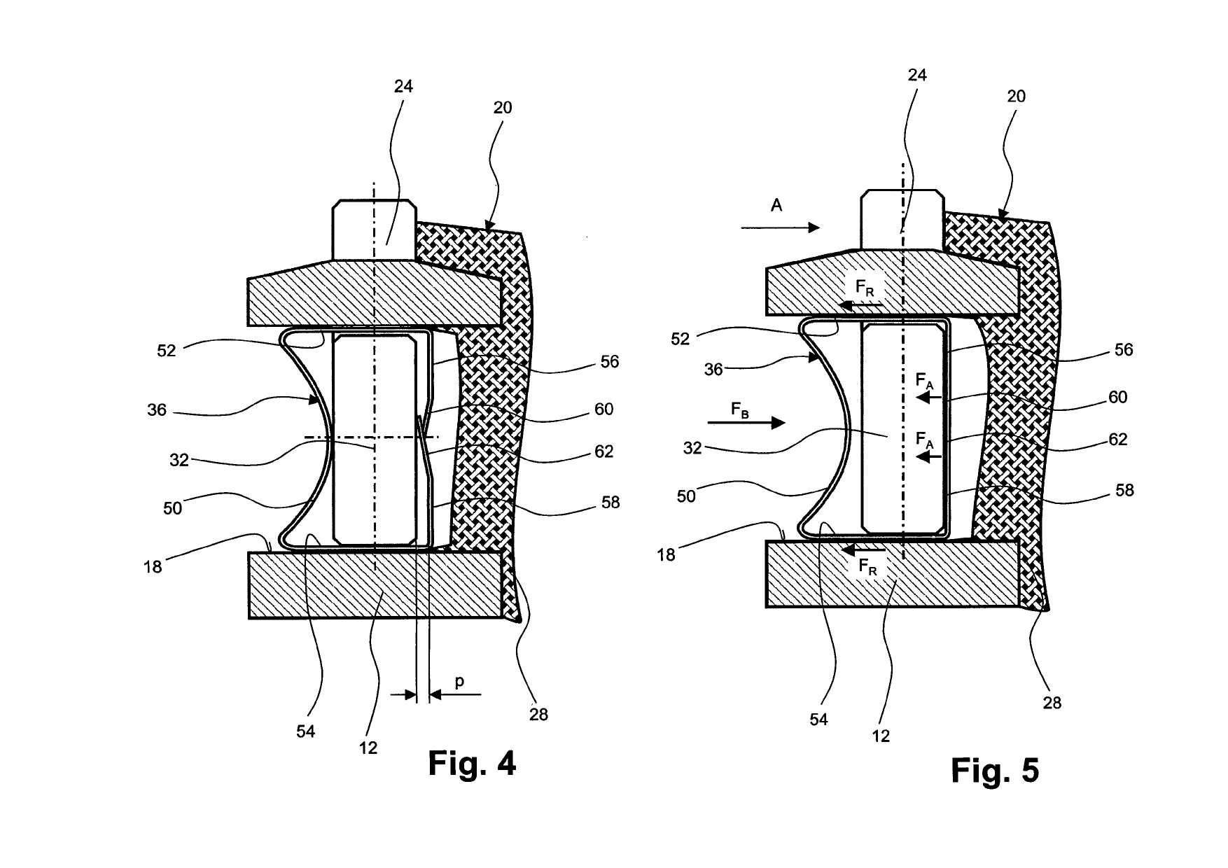

FIGS. 4 and 5 show the normal functioning. In FIG. 4 the initial state, i.e. the state before a brake actuation, is shown. Specifically, it can be seen that the spring arrangement 36 has a convexly curved back 50. The latter bears with it vertex approximately centrally against the side of the mounting tongue 32 facing away from the brake pad 28. Extending on either side of the back 50 in FIG. 4 substantially parallel to one another are spring support sections 52 and 54 which bear in a spring-biased state against the mutually facing inner surfaces of the receiving region 18. The spring bias is dimensioned such that the brake pad arrangement 20 is held in the receiving region 18 via the brake pad carrier 24, i.e. in particular via its mounting tongue 32, by means of the spring arrangement 36. In this case, the spring support sections 52 and 54 bear in a spring-biased state against the facing inner surfaces of the receiving region 18 and thus ensure friction retaining forces.

Extending from the spring support sections 52 and 54 are abutment sections 56 and 58, which merge via the bending points shown in FIG. 2 into bent-off spring tabs 60 and 62. The spring tabs 60 and 62 bear with their free ends in a spring-biased state against the side of the mounting tongue 32 facing the brake pad 20. Between the abutment sections 56 and 58 and the side of the spring tongue 32 facing the brake pad 28 is formed a play p, which is dimensioned greater than the clearance according to FIG. 1.

If the brake pad arrangement 20 is now moved as a result of a brake pedal actuation by acting on the brake pad carrier 24 with an actuation force F_{B} in the actuation direction A, the spring tabs 60 and 62 are elastically deformed in the corresponding direction. The brake pad arrangement 20 is initially moved until the movement play p is used up. If there is no significant wear on the brake pad 28, this movement play p is easily sufficient to carry out each brake actuation, i.e. to overcome the clearance s and furthermore to press the brake pad 28 sufficiently strongly against the brake disc 14 in accordance with the driver's desire. In the process, the deformation forces for elastically bending back the tabs 60 and 62 are less than the friction forces F_{R} which occur as a result of the spring bias of the spring support sections 52 and 54 in the receiving region 18. This means that in the course of a normal brake actuation, i.e. a brake actuation without wear compensation, the spring arrangement 36 remains in its position in the receiving region 18 and the brake pad arrangement 20 is only moved in accordance with the actuation force F_{B} in the direction of the arrow A.

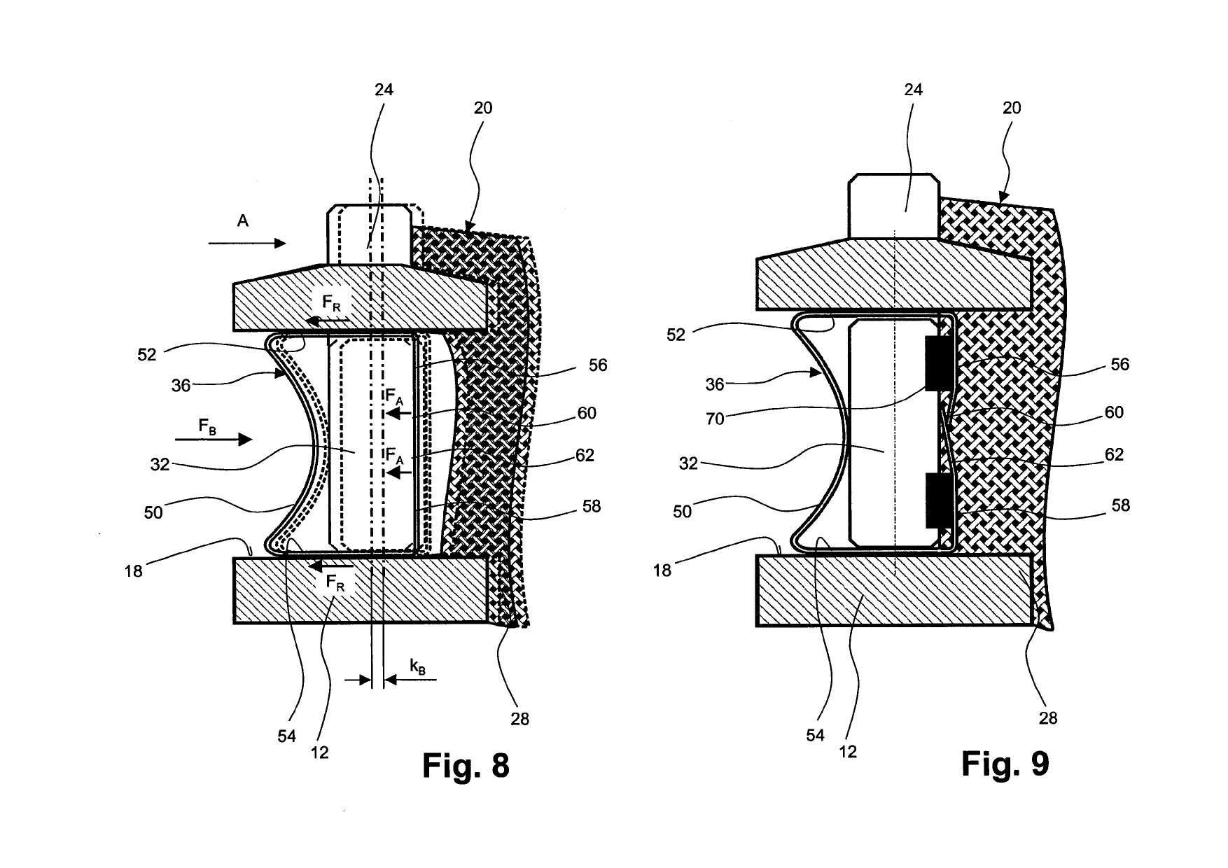

If, however, wear arises on the brake pad 28 due to repeated intensive actuation of the brakes, the clearance s becomes too large owing to the return movement. In order to compensate this wear and ensure a constant clearance s, it is necessary to move the brake pad arrangement 20 together with the spring arrangement 36 in the receiving region 18 in accordance with the arrow A towards the brake disc in order to restore the clearance shown in FIG. 1. A corresponding movement is shown in dashed lines in FIG. 8. The brake carrier 12 remains stationary during this. Such a movement occurs when the actuation force F_{B} is greater than the sum of the friction forces F_{R} and the movement play p (see FIG. 4) has been completely used up during a brake actuation. In such a situation, initially, as described with reference to FIG. 5, there results a state in which the two spring tabs 60 and 62 are deformed to such an extent that the side of the mounting tongue 32 facing the brake pad 28 bears in a form-fitting manner against the abutment sections 56 and 58 of the spring arrangement 36. Then, owing to the greater actuation force F_{B} due to the defined abutment of mounting tongue 32 and spring arrangement 36, the entire spring arrangement together with the brake pad arrangement 20 is displaced, towards the right in FIG. 8, along the actuation direction A and the braking is carried out accordingly.

When the driver releases the brake pedal again, so that the actuation force F_{B} is removed, the brake pad arrangement 20 moves back, in accordance with the described functioning, due to the return forces of the spring tabs 60 and 62 until the movement play p and the clearance s are finally restored. The brake is so to speak in the desired initial state again, apart from the compensated pad wear which has been achieved by the forward movement of the brake pad arrangement 20 together with the spring arrangement 36. The compensated pad wear is denoted by the distance k_{B} in FIG. 8. This corresponds exactly to the distance by which the spring arrangement together with the brake pad arrangement 20 has been permanently displaced towards the right.

The invention has the advantage that a clear distinction is made between a normal brake actuation and a pad wear compensation. Only when the clearly defined movement play p has been completely used up, and due to the actuation force F_{B} the brake pad 28 can still be advanced to the brake disc, does a defined wear compensation automatically result. This functioning can be reliably achieved by the present invention. The constructional means required for this are simple and cost-effective.

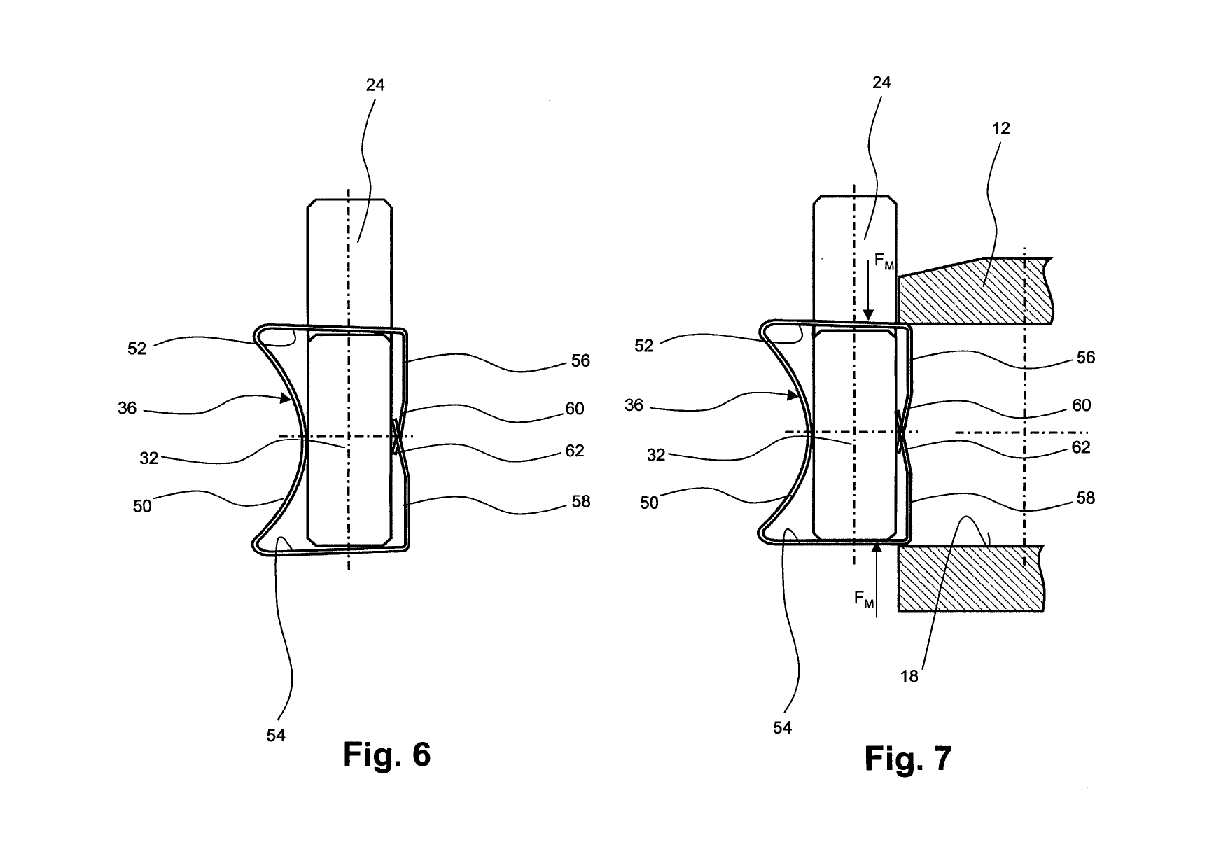

FIGS. 6 and 7 show the mounting of the spring arrangement according to the invention with a corresponding brake pad carrier (the brake pad has been omitted to simplify the drawing) in the brake carrier 12 of the disc brake. It can be seen that the sides of the support sections 52 and 54, starting from the back 50, are inclined inwards towards one another and extend towards the right in FIG. 6, i.e. at an acute angle to one another. In other words, these spring support sections 52 and 54 taper in a spring-biased state starting from the back 50. Consequently, they form a kind of introducing slope for simplified mounting, where the support sections 52 and 54 in the region of the back 50, in the unmounted state, are at a greater distance from one another than the width of the receiving region 18 on the brake carrier 12, while the region of the support sections 52 and 54 facing away from the back by the angling-off of the support sections 52 and 54 has a slightly smaller spacing. During mounting, the mounting forces F_{M} act on the two support sections 52 and 54 to enable insertion. During this, the support sections 52 and 54 are gradually further pressed together in the region of the back 50, with the back 50 yielding elastically in accordance with the degree of overlap. This gives rise, in the region of the connection of the support sections 52 and 54 to the back 50, to a maximum bias which is decisive for the fixing of the spring arrangement 36 in the receiving region 18. This spring bias ensures the occurrence of the friction forces by which the spring arrangement 36 is held in the receiving region 18.

FIG. 9 shows a modification of the embodiment according to FIGS. 1 to 8. The only difference from above-described embodiment is that a filling ring 70 is arranged in the region between the mounting tongue 32 and the abutment sections 56 and 58 of the spring arrangement 36, which filling ring prevents undesired ingress of abraded material into this region and thus guards against a soiling-related malfunction, for example a reduced movement play p.

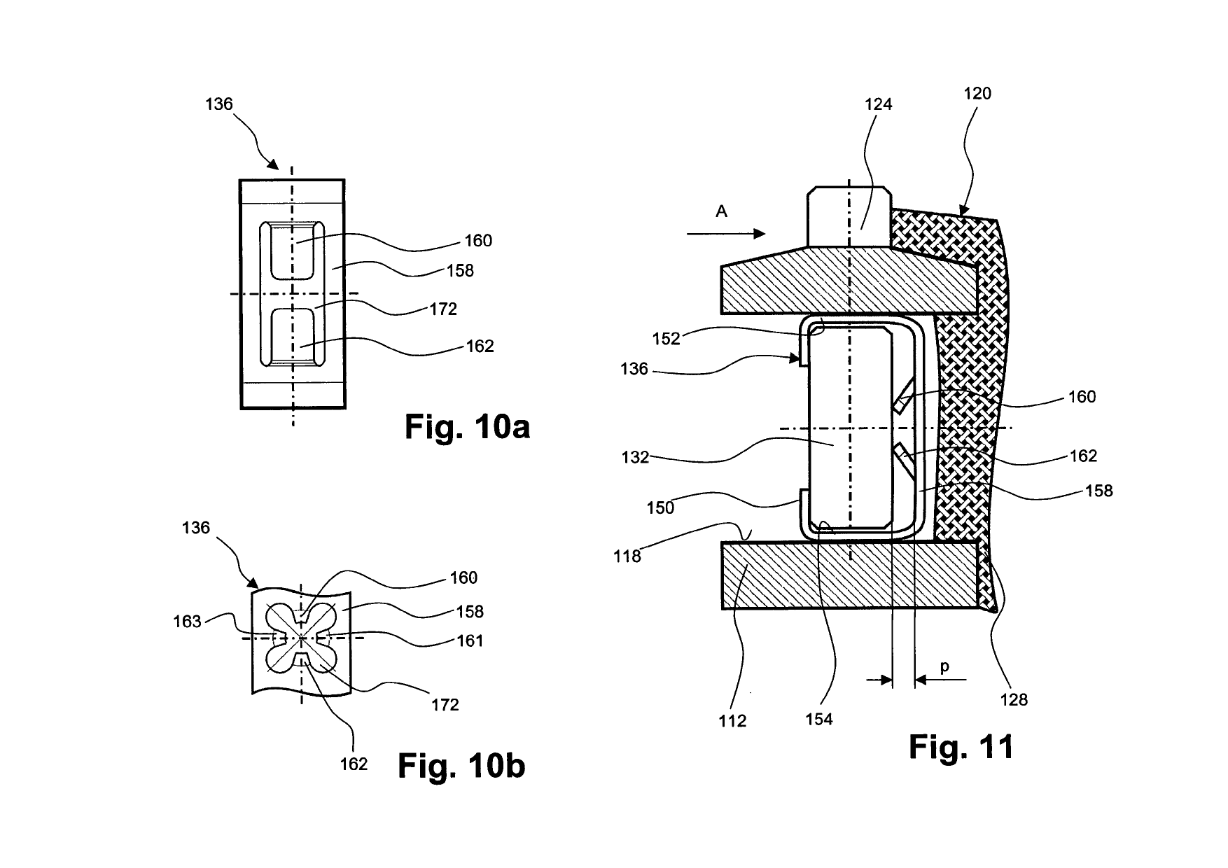

FIGS. 10a and 11 show a further embodiment of the invention, the same reference symbols being used as above, but prefixed with the numeral “1”, for components acting in the same way or of the same kind.

The spring arrangement 136 according to FIG. 11 differs from the spring arrangement 36 of the above embodiments in that it has a C-shaped band, out of which the two spring tabs 160 and 162 are bent in the abutment section 158. The spring back 150 is of interrupted form. The two spring support sections 152 and 154 are again spread outwards and bear in a spring-biased state against the receiving region 118. FIG. 10 shows the spring arrangement 136 in a view from the left. It has in its central region a H-shaped cutout 172 which serves for forming the two spring tabs 160 and 162. The functioning of this embodiment is the same as described above. During normal brake actuation, the movement play p is initially used up. Only when a defined form-fitting abutment results between the mounting tongue 132 and the abutment section 158, does a wear compensation become possible.

FIG. 10b shows an embodiment slightly modified with respect to FIG. 10a. A cutout in the form of a four-leaf clover is provided in the spring back 150, resulting in spring tabs 160, 161, 162, 163 situated radially inwards towards the centre, which protrude from the plane of the spring back 150 similarly to the spring tabs according to FIG. 10a and determine the spring travel providing the play p. In this embodiment of the invention, the forces acting on the spring arrangement are uniformly distributed.

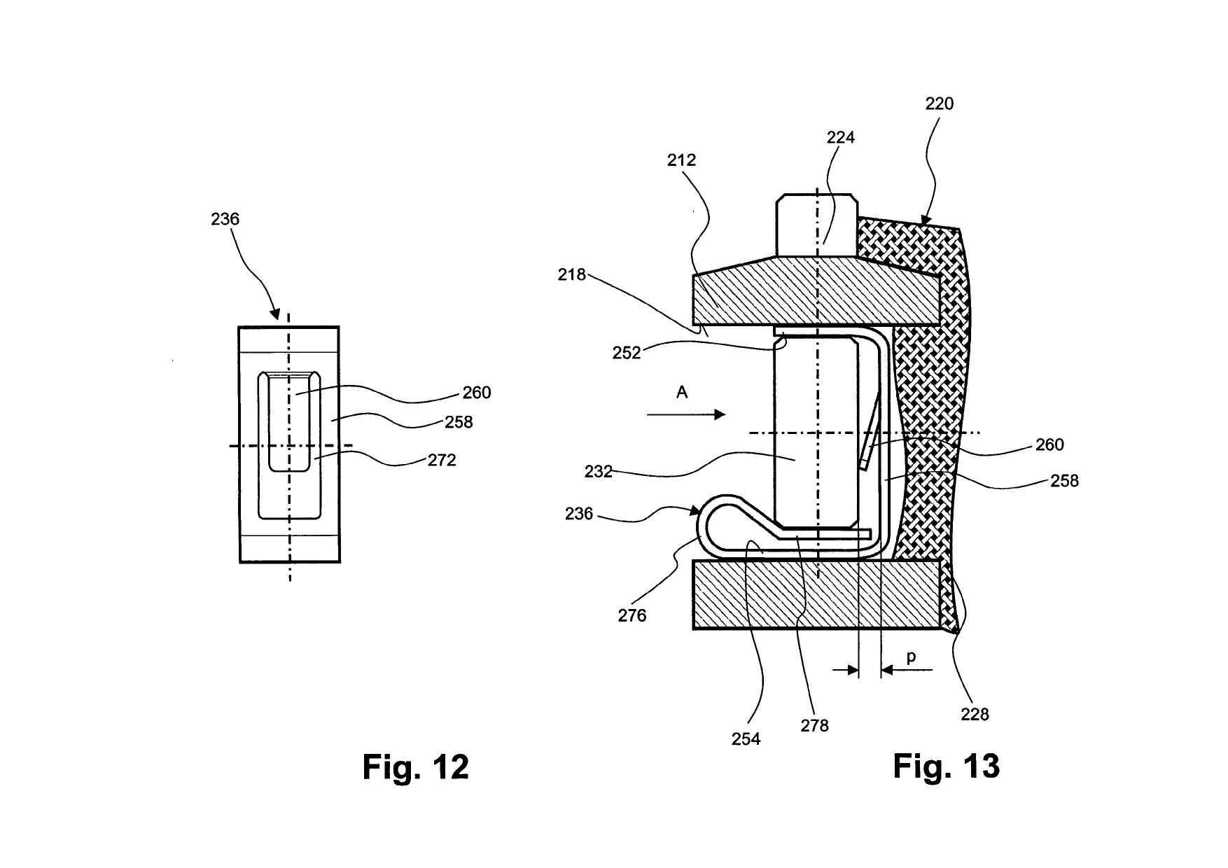

FIGS. 12 and 13 show a further embodiment of the invention. Again, the same reference symbols are used, but prefixed with the numeral “2”, for components acting in the same way or of the same kind.

In FIG. 13 it can be seen that the spring element 236 merges from its spring support section 254 into a loop-shaped spring bend 276. This loop-shaped spring bend 276 extends up to a linear free section 278 which is biased resiliently upwards. This shape causes the spring arrangement 236 to clamp the mounting tongue zone 232 securely between the support section 252 and the support section 254. As a result, a play in the transverse direction to the actuation direction A can be suppressed.

FIG. 12 again shows a view corresponding to FIG. 10. It can be seen that only one spring tab 262 is provided, which is surrounded by a U-shaped cutout 272 and has been formed thereby.

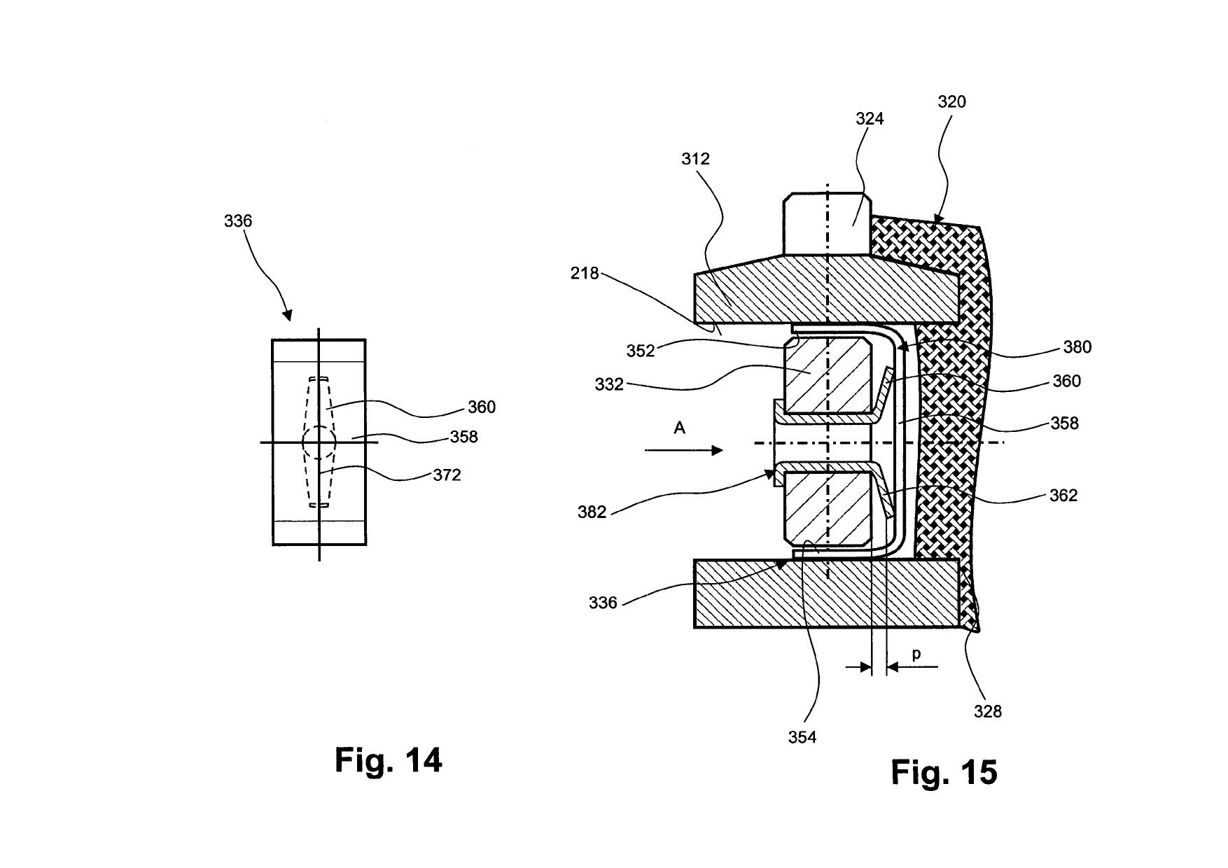

FIGS. 14 and 15 show a further embodiment of the invention. Again, the same reference symbols are used, but prefixed with the numeral “3”, for components acting in the same way or of the same kind.

The embodiment according to FIGS. 14 and 15 differs from the above embodiments in the configuration of the spring arrangement 336. The spring arrangement 336 comprises two components, namely a C-shaped spring bow 380 which has the two spring support sections 352 and 354. Furthermore, the spring arrangement 336 comprises a spring element 382 which passes through the mounting tongue 332 in an opening and is spread out on the side facing the brake pad 328. In this region, it has two spring tabs 360 and 362 which bias the spring bow 380 into the position shown in FIG. 15. As a result of an actuation, the movement play p can be used up until a wear compensation finally takes place, as described above. The material thickness of the spring tabs 360 and 362 is to be taken into account in the dimensioning of the movement play p.

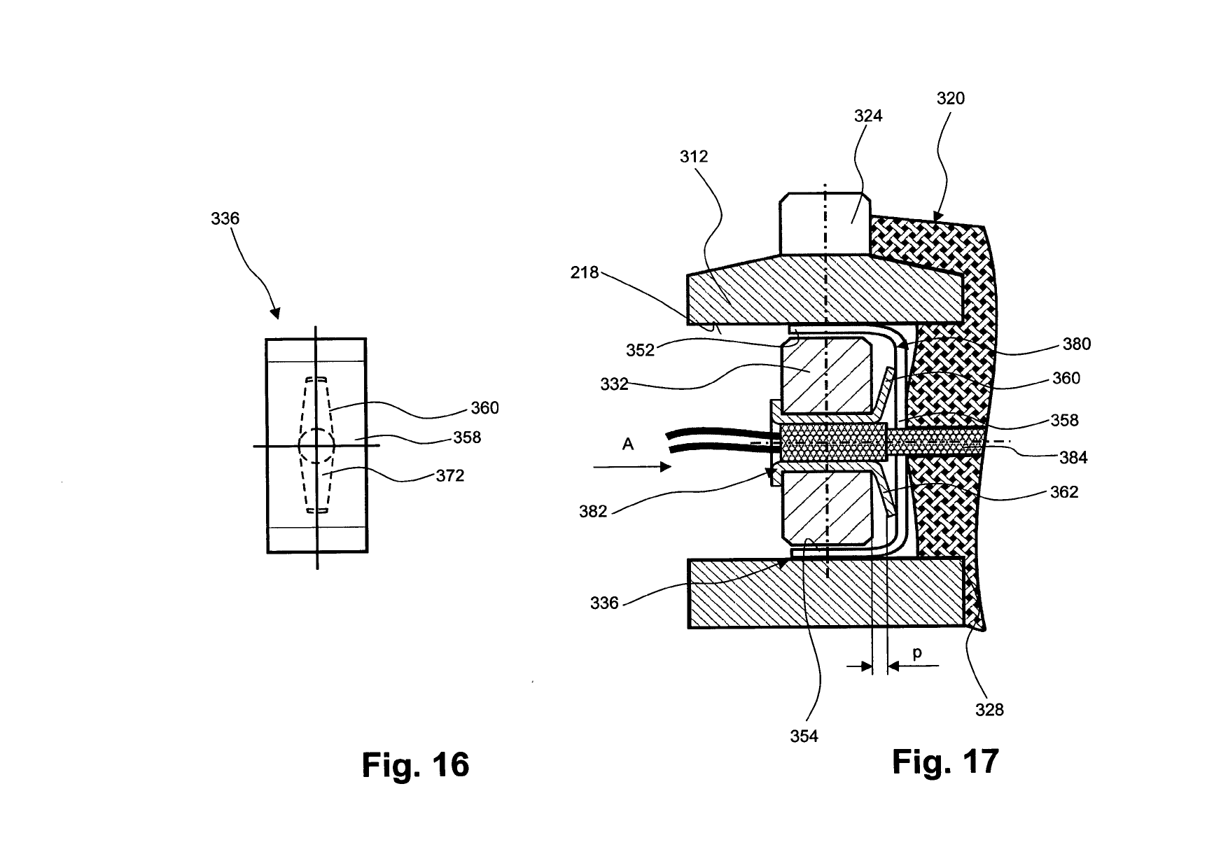

FIGS. 16 and 17 show a further embodiment of the invention. Again, the same reference symbols are used, but prefixed with the numeral “3”, for components acting in the same way or of the same kind.

The embodiment according to FIGS. 16 and 17 differs from the embodiment according to FIGS. 14 and 15 only in that a pad wear sensor 384 is inserted into the spring arrangement 336, which sensor for sensing the pad wear can provide output to an electronic control unit of the motor vehicle via the connection cables running out of the pad wear sensor 384.

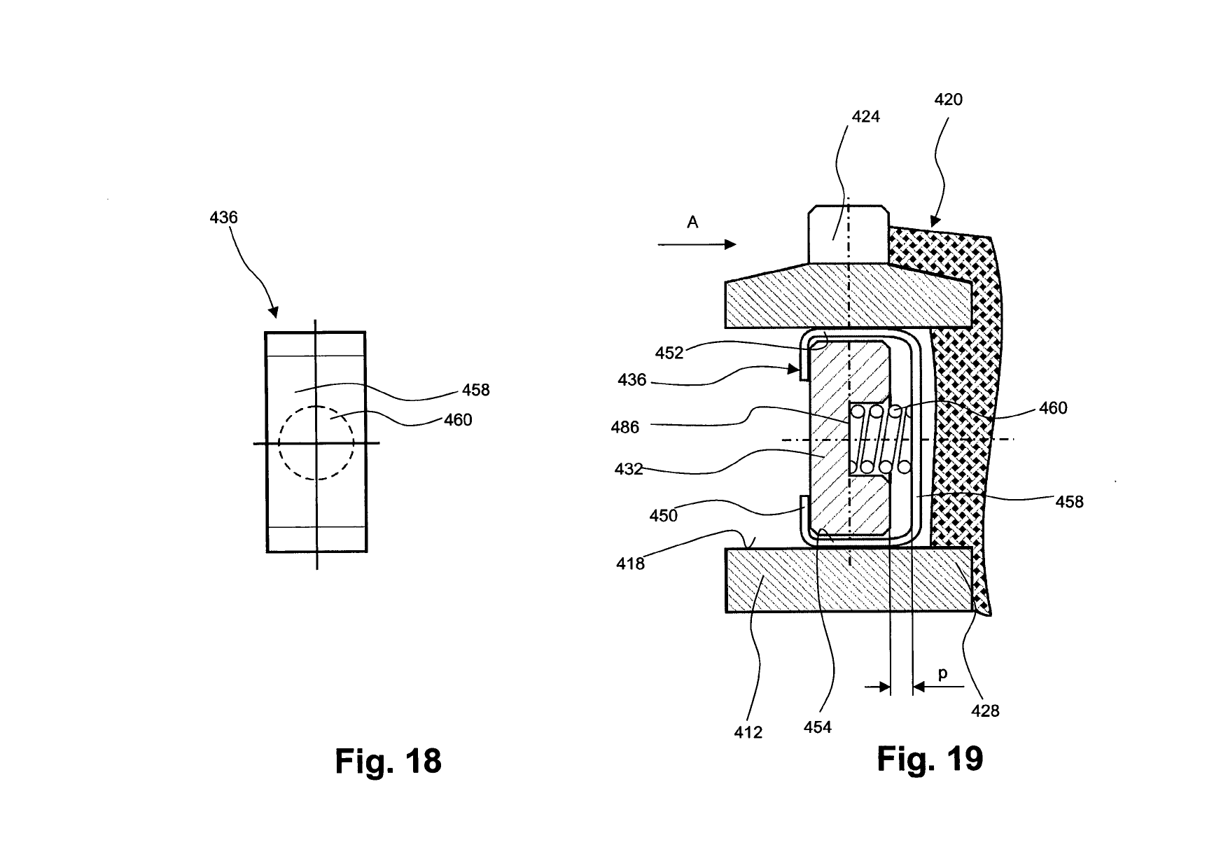

FIGS. 18 and 19 show a further embodiment of the invention. Again, the same reference symbols are used, but prefixed with the numeral “4”, for components acting in the same way or of the same kind.

The embodiment according to claims 18 and 19 is similar to the embodiment according to FIG. 11, with the spring tabs 160 and 162 therein being replaced by a separate spring element 460. The latter is received in a recess 486 in the mounting tongue 432. The spring element 460 is configured as a helical compression spring. This spring element 460 is designed such that it is fully compressed only when the movement play p is used up. A defined form-fitting abutment between the mounting tongue 432 and the spring arrangement 436 is thereby ensured.

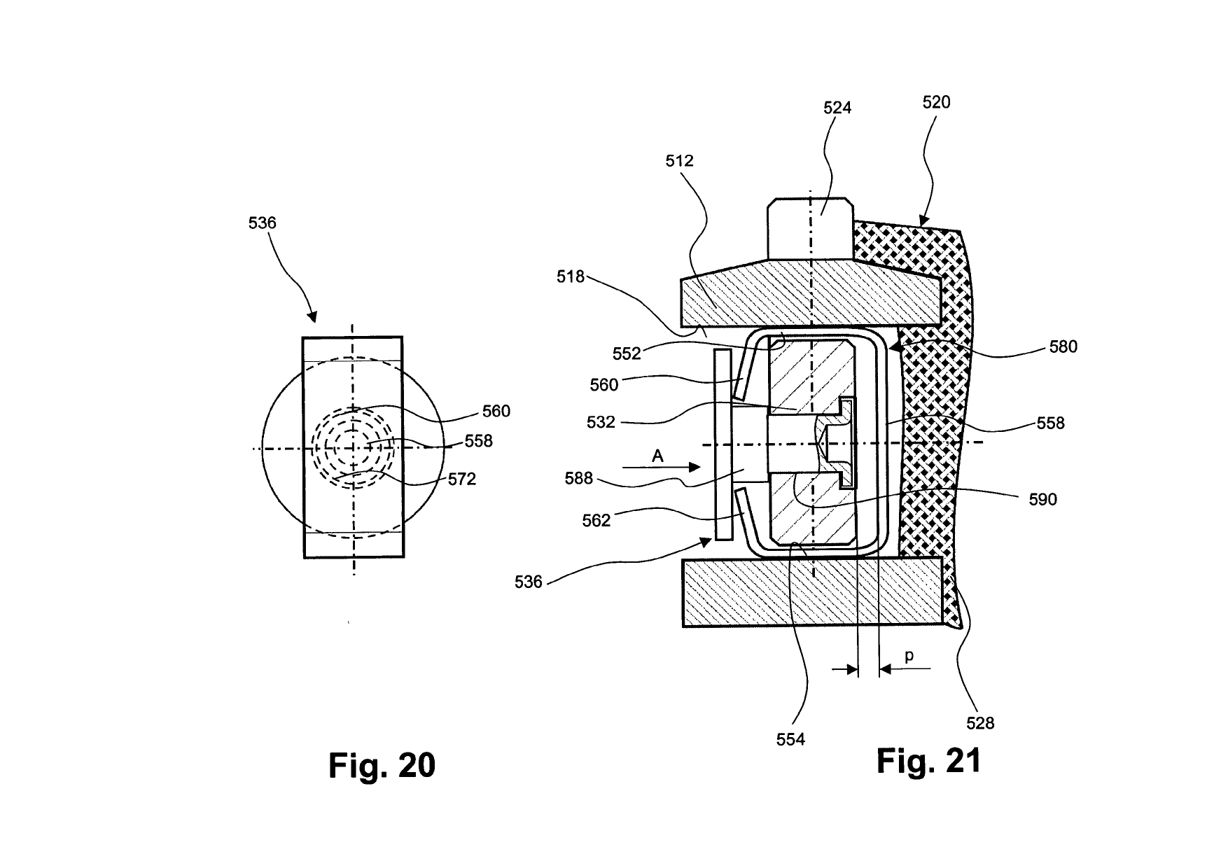

FIGS. 20 and 21 show a further embodiment of the invention. Again, the same reference symbols are used, but prefixed with the numeral “5”, for components acting in the same way or of the same kind.

The embodiment according to FIGS. 20 and 21 provides that a bolt-like support element 588 extending through an aperture 590 formed in the mounting tongue 532 is provided. A C-shaped spring element 580 is supported, with its spread legs 552 and 554 and the spring tabs 560 and 562 formed thereon, resiliently on this support element 588, in particular on its flange-like head. As the movement play p is used up, the spring tabs 560 and 562 are elastically deformed by forward movement of the unit composed of mounting tongue 532 and support element 588.

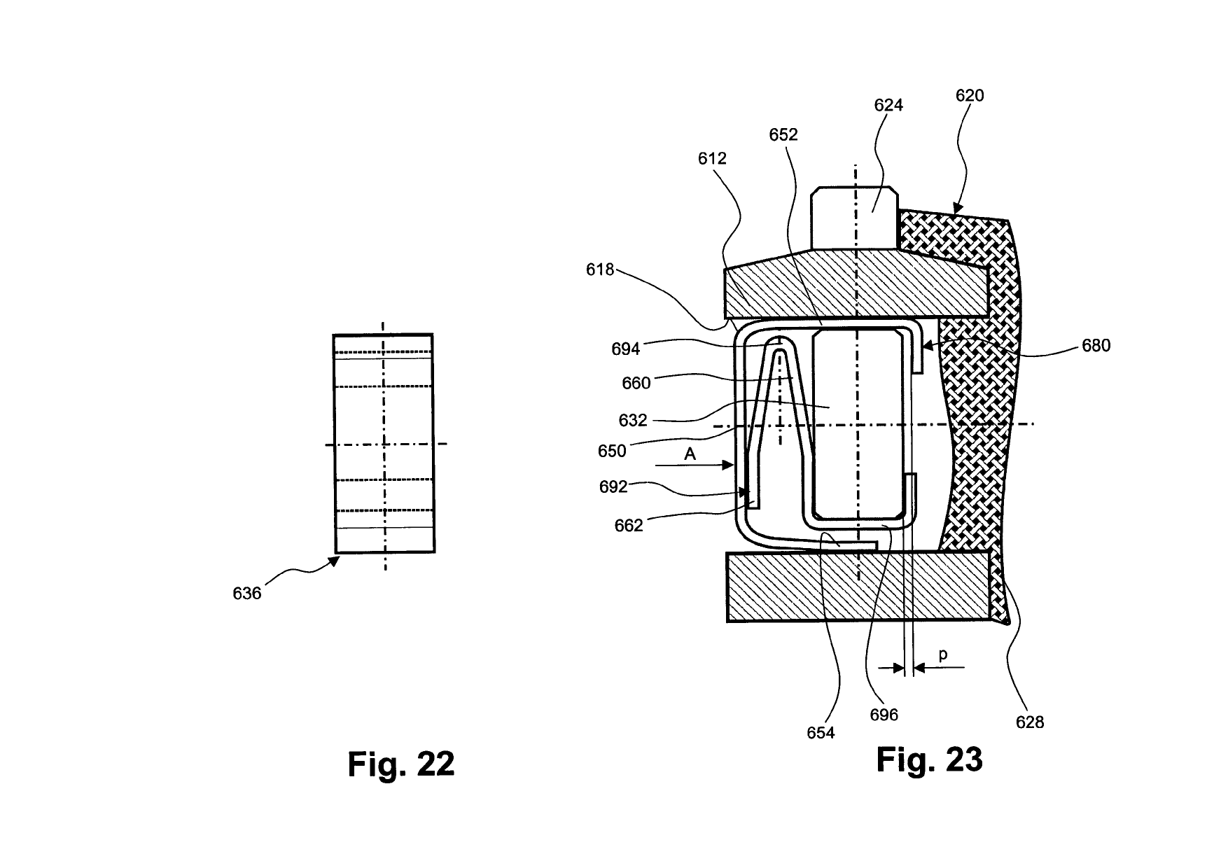

FIGS. 22 and 23 show a further embodiment of the invention. Again, the same reference symbols are used, but prefixed with the numeral “6”, for components acting in the same way or of the same kind.

In the embodiment according to FIGS. 22 and 23 too, the spring arrangement 636 is formed of more than one part. Between the mounting tongue 632 and the C-shaped spring element 680 there is provided a spring element 692 folded in a V-shape. The latter comprises a first spring section 660 and a second spring section 662 which are folded in a V-shape with respect to one another in a smooth-running folding region 694. The spring section 662 is connected to the back 650 of the spring element 680 by riveting or welding or another suitable fastening manner. The spring element 692 has, adjoining the spring section 660, a receiving pocket 696 which embraces the mounting tongue 632 in a form-fitting manner. During a normal brake actuation, the mounting tongue 632 together with the entire brake pad arrangement 620 is moved along the movement direction A, reducing the movement play p. In the process, the spring element 692 spreads open elastically. The mounting tongue 632 is held in a manner free from play, so that undesired noises can be suppressed.

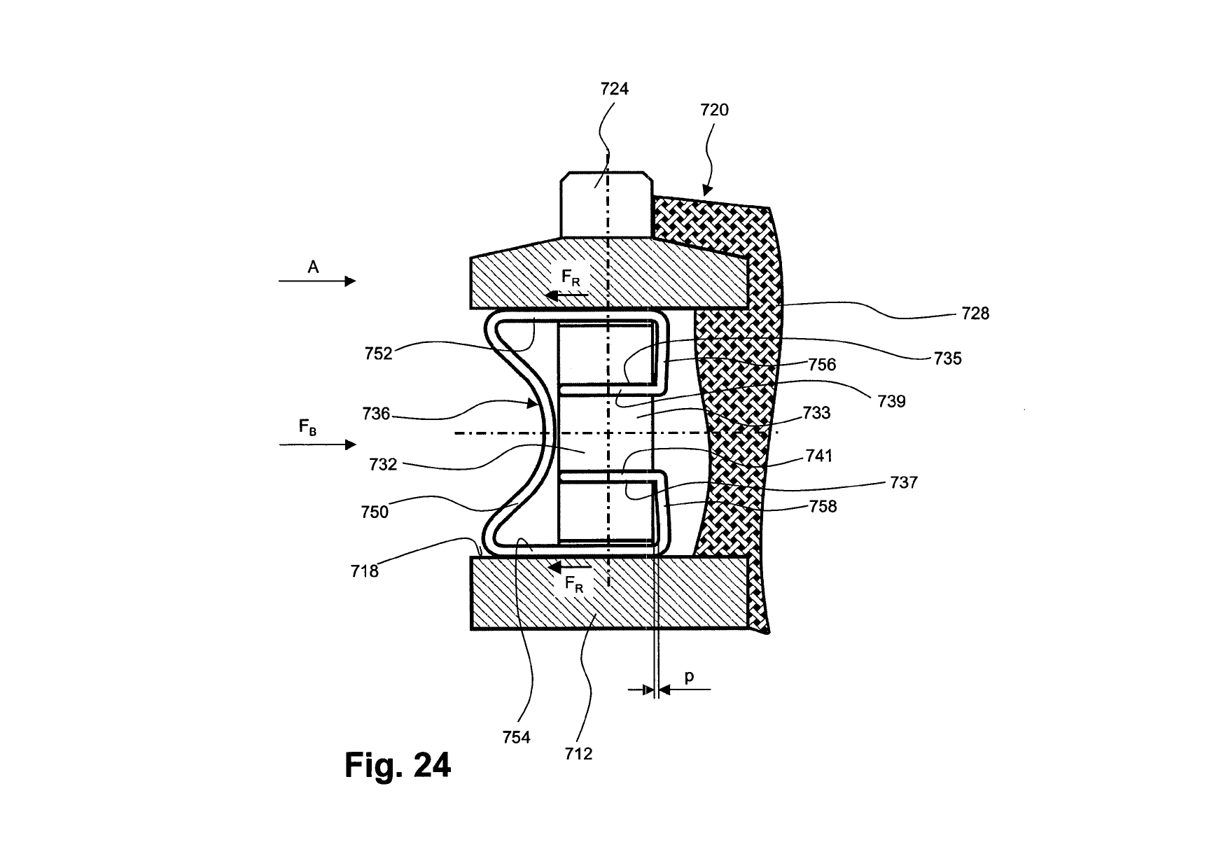

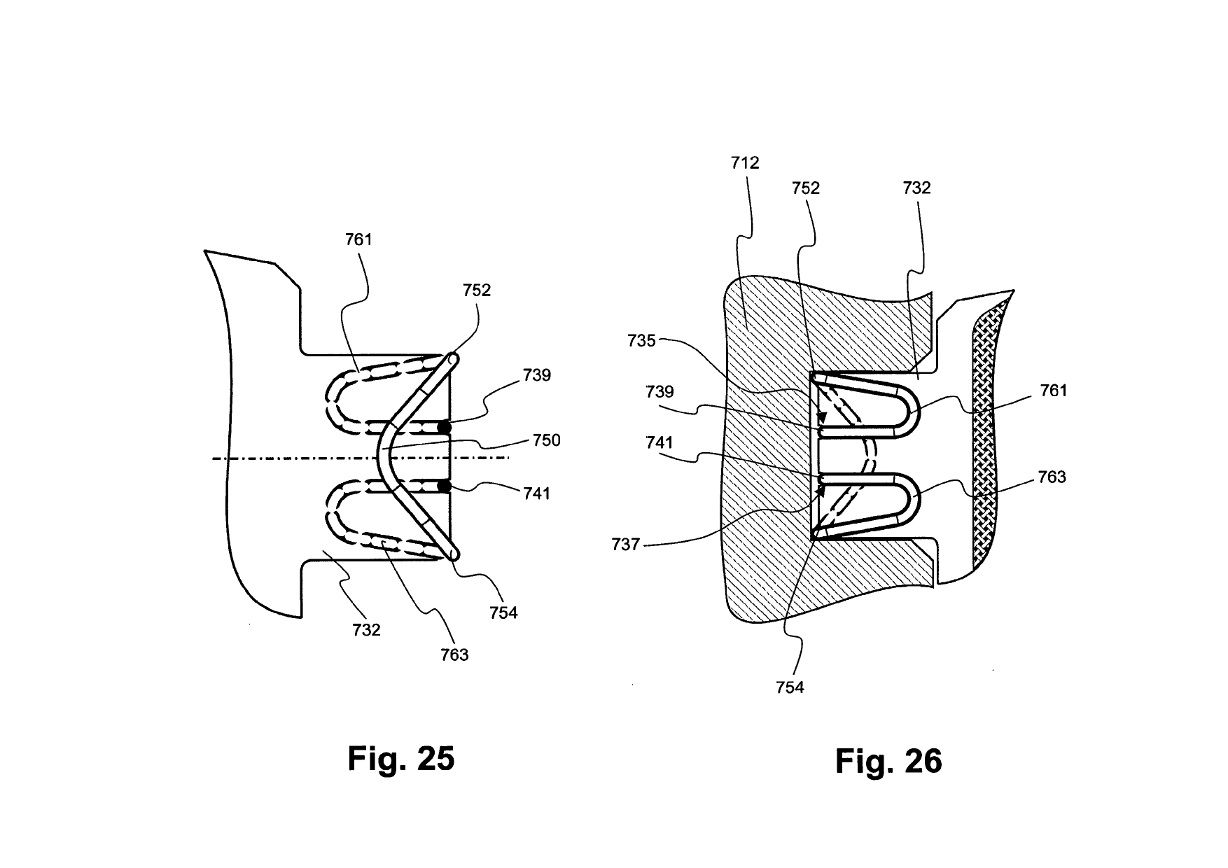

FIG. 24 shows a further embodiment of the invention, in which the spring element is formed as a spring clip from a multiply bent spring wire. The mounting tongue 736 has, as can also be seen in FIG. 25 and FIG. 26, recesses at its front face 733. Holding arms 739, 741 are received in a form-fitting manner in these recesses 735, 737, so that the spring element 736 is securely mounted on the mounting tongue 732. Extending from the holding arms 739, 741 in an angled-off manner are spring loops 761 and 763, their spacing from the spring tongue 732 increasing, with increasing distance from the holding arms 739 and 741, finally to the spacing p. In the outer region, the two spring loops 761 and 763 merge into the spring support sections 752 and 754, with which the spring element 736 bears with the friction force F_{R} against the mutually facing surfaces of the receiving region 718. The spring back 750 is again of bow-shaped form and extends in a curved manner, as shown in FIG. 25, on the side of the mounting tongue 732 facing away from the brake pad 728.

In FIGS. 25 and 26 can be seen in each case the loop-shaped course of spring back 750 and spring loops 761 and 763. The holding arms 739 and 741 end, on the left in FIG. 24, substantially flush with the mounting tongue 732.

The functioning is similar to that described above. A normal brake actuation for moving the brake pad takes place within the play p, the spring loops 761, 763 being elastically deformed over their course during this while using up the play p. Only in the wear state when the play p due to wear is no longer sufficient for brake actuation, the actuation force becomes so great that it overcomes the friction forces F_{R}, thus resulting, with neutralisation of the static friction at the spring support sections 752 and 754, in a wear-compensating movement of the entire arrangement inside the receiving region 718.

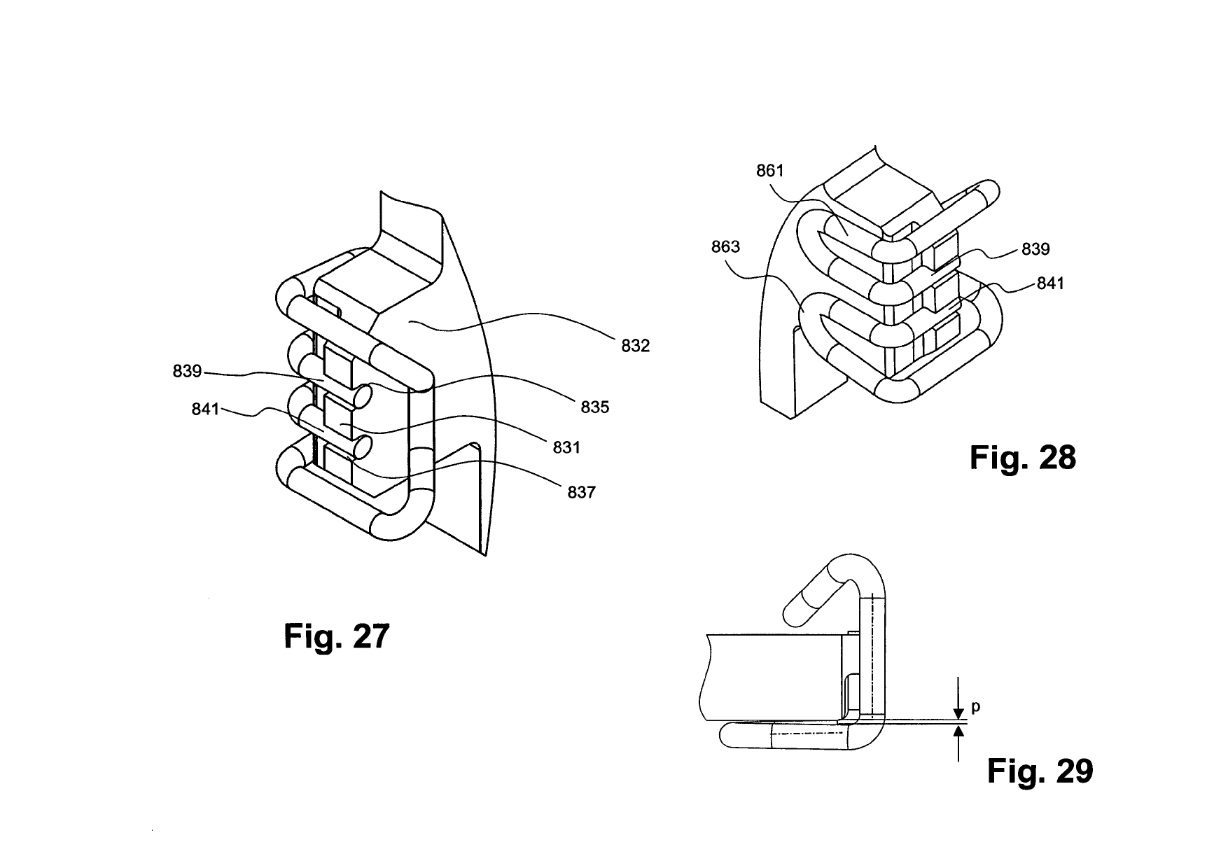

FIGS. 27 to 29 show an embodiment slightly modified with respect to the embodiment according to FIGS. 24 to 26. In this case, the recesses 835 and 837 are formed in a projection 831 of the mounting tongue 832. Otherwise, the functioning and design is substantially identical to the embodiment according to FIGS. 24 to 26, i.e. the spring loops 861 and 863 extend in such a manner, starting from their holding arms 839 and 841, that the play p is provided over the course of the spring loops 861 and 863. This can be seen again in FIG. 29, which shows that the play p is provided by the oblique course of the spring loop 861 with respect to the side of the mounting tongue 832 lying opposite this loop.

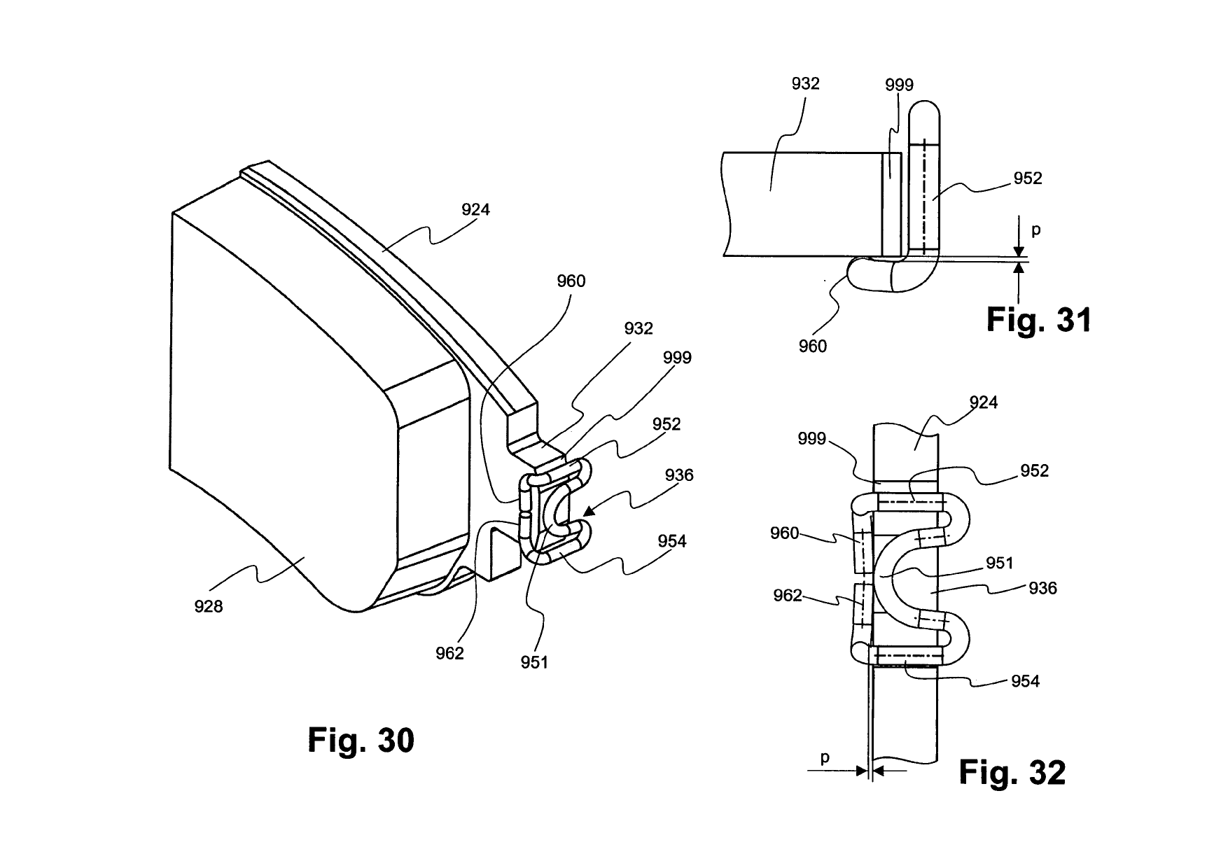

FIGS. 30 to 32 show a further embodiment of the invention in different views. The spring element 936 formed as a spring clip is again substantially closed. The spring travel p is provided by the two spring shackles 960 and 962 which are placed on obliquely to the mounting tongue 936, as can be seen in FIG. 31. The abutment against corresponding abutment surfaces in the receiving region takes place once again via the two spring support sections 952 and 954 which run in the region of bevels 999 of the mounting tongue 936. The spring clip is closed via a support loop 951 which likewise bears against the receiving region with generation of a friction force and thus allows a relative movement between brake disc carrier and disc brake housing only when the actuating play p is used up and a compensation is required.

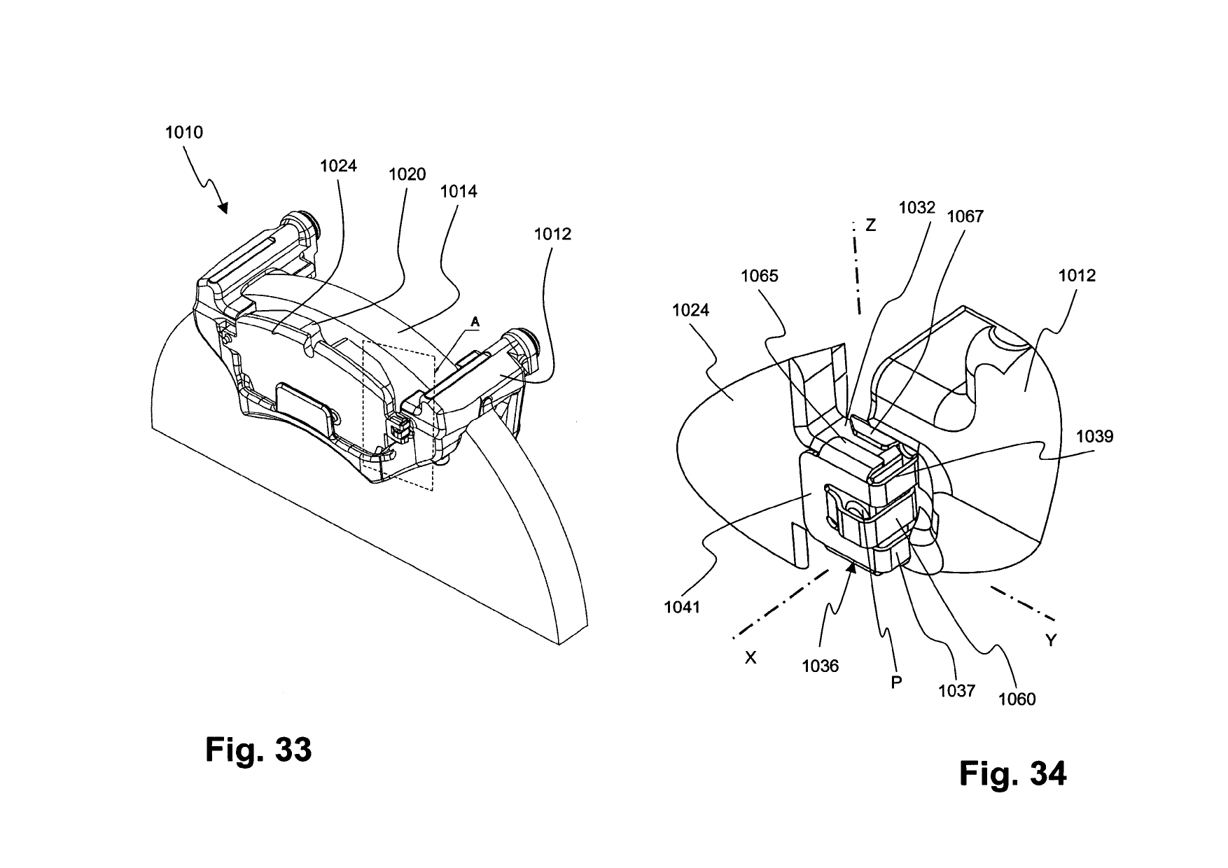

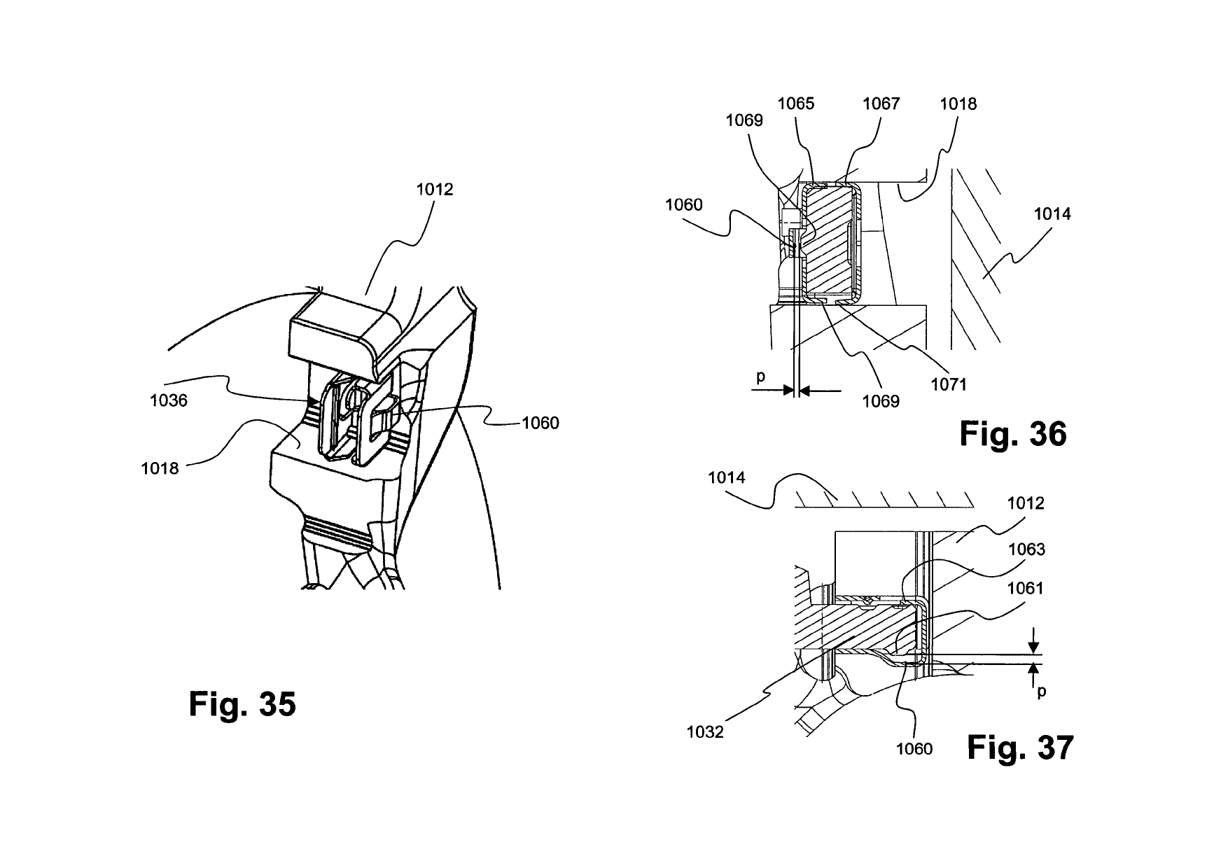

FIGS. 33 to 37 show a further embodiment of the invention in different views, with the brake carrier 1012 which straddles the brake disc 1014 being shown. FIG. 33 shows in particular how the brake pad carrier 1024 with the brake pad 1020 is received in the brake carrier 1012. FIG. 34 shows the region, denoted by A in FIG. 33, in an enlarged view, with the brake pad carrier 1024 having a mounting tongue 1032 in the manner described in principle. This tongue is surrounded by a clip-like spring element 1036 made of a folded spring metal sheet which has two parallel-running fastening arms 1037, 1039 which embrace the mounting tongue 1032 on three sides and are connected to one another at their ends by a transverse clasp 1041. A spring tab 1060 extends from the transverse clasp 1041. The spring tab 1060 is configured in such a manner that it is arranged in the initial state with play p (see FIG. 36) at a distance from an abutment projection 1061 on the mounting tongue 1032. At the region facing the brake disc 1014, the spring tab 1060 lies in an abutment section 1063 in abutment with the mounting tongue 1032.

On the two fastening arms 1037, 1039 there are provided in each case clamping extensions 1065, 1067, 1069, 1071 which are angled off around the mounting tongue 1032 and via which the brake pad carrier 1024 is held in the receiving region 1018 with static friction.

The functioning as regards the actuation and wear compensation is the same as described above. The play p is sufficient to move the brake pad carrier 1024 together with the brake pad 1020, against the spring action of the spring tab 1060, towards the brake disc 1014 and carry out braking. After release of the brake pad carrier, the latter moves due to the spring action of the spring tab 1060 back into its initial position shown in the figures. In other words, the spring tab 1060 pulls the brake pad carrier 1024 back into its initial position. A compensation of a pad wear is achieved in that the brake pad carrier with the brake pad is permanently displaced in the receiving region 1018 under the effect of the brake actuation device. In the position compensating the pad wear, the spring arrangement 1036 then adheres again, similarly to the way shown in FIGS. 36, 37, but in a position moved forwards in accordance with the wear compensation.

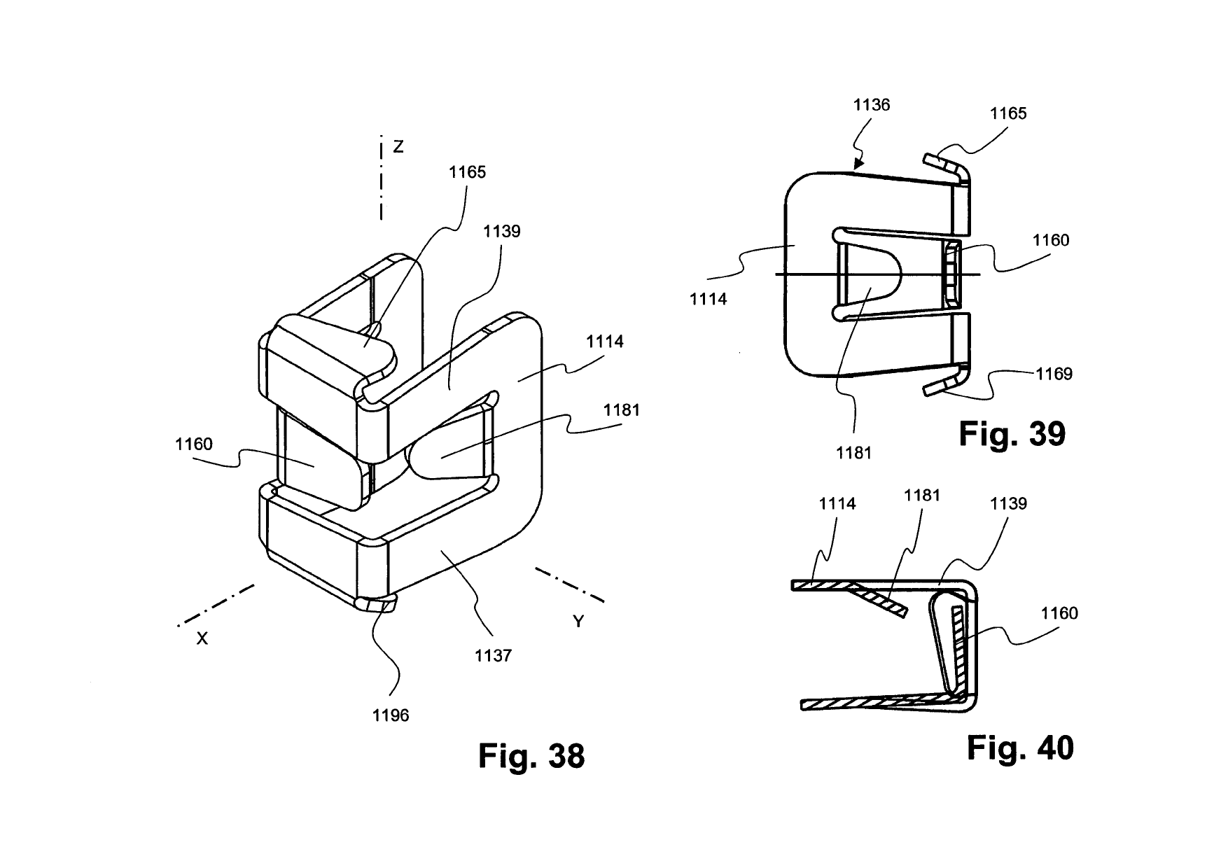

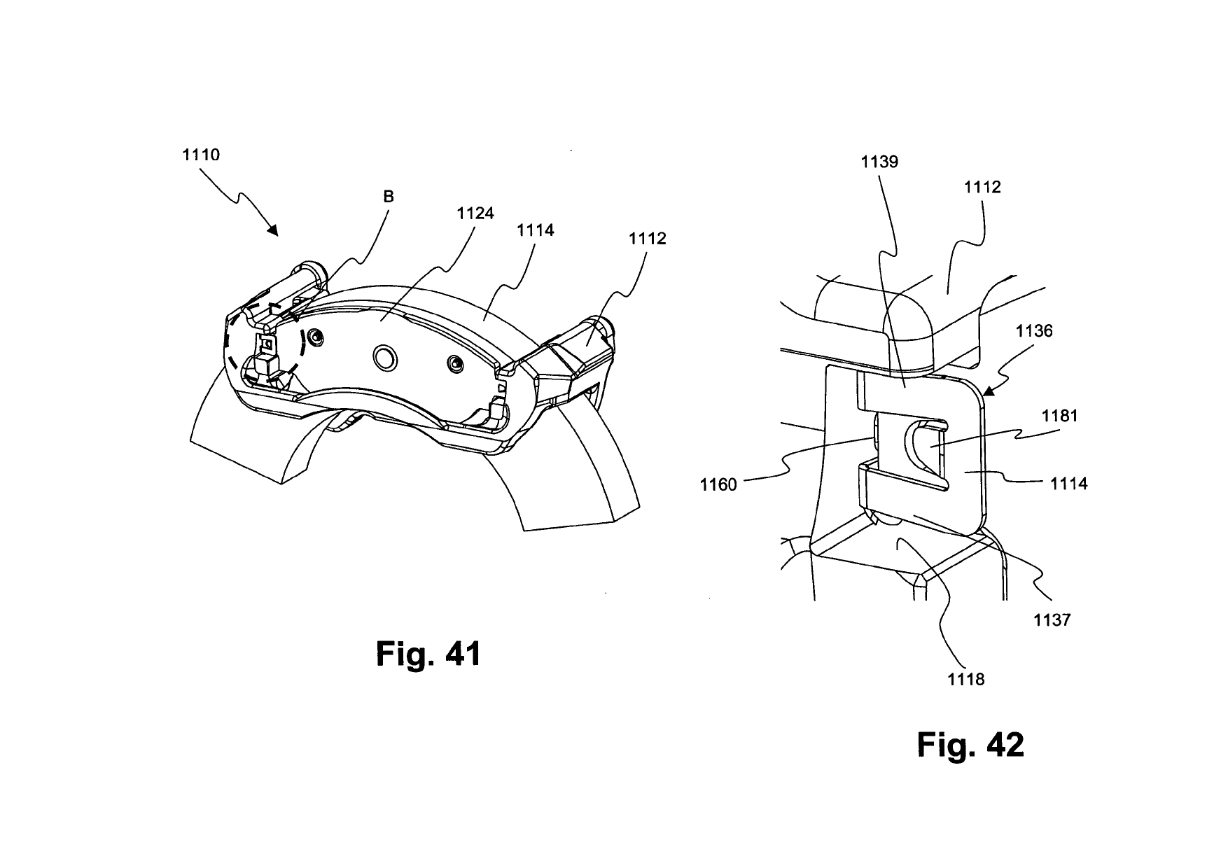

FIGS. 38 to 42 show a further embodiment of the invention which is similar to the embodiment according to FIGS. 33 to 37 in construction and functioning. For components of the same kind or acting in the same way, therefore, the same reference symbols are used, but increased by the amount “100”.

The embodiment according to FIGS. 38 to 41 differs as regards the spring arrangement 1136 in that the latter does not pull, but pushes the brake pad carrier 1124 together with the brake pad back into the initial position. For this purpose, the spring tab 1160 is arranged on the other side facing the brake disc 1114. As can be seen in the views according to FIGS. 38, 39 and 40, the spring tab 1160 is offset inwards and slightly obliquely angled off with respect to the holding arms 1137, 1139 (see FIG. 40). On the opposite side facing away from the brake disc 1114, the spring arrangement 1136 is supported with its return arm 1181 against the mounting tongue 1132. Furthermore, the two holding tabs 1165 and 1169 are arranged on the end side of the two holding arms 1137 and 1139 and extend obliquely upwards and downwards therefrom, respectively. The functioning is, however, in principle the same as already described with reference to FIGS. 33 to 37, except for the fact that the brake pad arrangement is pushed back.

Overall, with all the embodiments of the invention, what is achieved is that a distinction can be made in a defined manner between a normal brake actuation without wear compensation and a brake actuation with wear compensation. Only when a defined, in particular form-fitting, abutment results between the mounting tongue and the spring arrangement, that is to say only when the movement play p is used up, does a wear compensation occur. It is thereby ensured that—whatever the state of wear of the brake pad arrangement—a normal braking always takes place under the same force conditions. An increase in the actuation forces due to wear, as is known from the prior art, does not occur in the invention.

The individual components of the spring arrangement can be formed from sheet-metal parts from spring steel or from spring wire. The individual bending points are formed smoothly based with suitable transition radii. As a result, the spring stiffness of the respective spring arrangement can be adjusted.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. Disc brake for a motor vehicle, comprising a guide, in which at least one brake pad arrangement is moveably guided for achieving a brake effect, wherein the brake pad arrangement has a brake pad carrier, on which a vehicle brake pad is mounted, which can be brought into interaction with a brake disc (14) for achieving a brake effect, wherein the brake pad carrier has at least one mounting tongue and wherein the guide has at least one receiving region, wherein the mounting tongue is receivable in the at least one receiving region such that it is guided in an actuation direction, wherein a spring arrangement is mounted on the at least one mounting tongue, by means of which spring arrangement a return force due to an elastic deformation caused by a deflection of the brake pad arrangement in order to achieve a brake effect can be applied thereon,
wherein the spring arrangement has spring support sections, by means of which the spring arrangement is supported in a biased state in the receiving region, and that the spring arrangement provides a predetermined spring travel, which is dimensioned such that a movement of the brake pad carrier for actuating the brake is permitted without brake pad wear compensation and such that when using up the predetermined spring travel the brake pad arrangement contacts the spring arrangement for brake pad wear compensation and moves the latter spring arrange within the guide in order to compensate brake pad wear.

2. Disc brake according to claim 1,
wherein the spring arrangement embraces the mounting tongue, the spring arrangement having, on the side facing the brake pad, at least one abutment section which is spaced, at least in sections, by the predetermined spring travel from the mounting tongue.

3. Disc brake according to claim 2,
wherein at least one spring means is provided between the brake pad and the side of the spring arrangement facing the brake pad.

4. Disc brake according to claim 2,
wherein at least one spring means is provided between the brake pad and the side of the spring arrangement facing away from the brake pad.

5. Disc brake according to claim 4,
wherein the at least one spring means has at least one spring shackle which is formed on the spring arrangement and bears resiliently against the mounting tongue.

6. Disc brake according to claim 5,
wherein the at least one spring shackle is formed by a protruding spring tab which is formed in one piece on the spring arrangement or fastened in a force-fitting or form-fitting manner thereto.

7. Disc brake according to claim 6,
wherein the spring tab is of V-shaped form.

8. Disc brake according to claim 3,
wherein the mounting tongue is provided, on a side of the mounting tongue facing the brake pad, with a spring holding means, on which spring holding means is mounted a separate spring element which is supported against the mounting tongue and against the spring arrangement.

9. Disc brake according to claim 3,
wherein the at least one spring means is formed by a compression spring or a leaf spring which passes through the mounting tongue at least partially.

10. Disc brake according to claim 2,
wherein the spring arrangement is received in a form-fitting or force-fitting manner in recesses of the mounting tongue.

11. Disc brake according to claim 10,
wherein the spring arrangement is formed by a partially or completely closed spring clip.

12. Disc brake according to claims 5,
wherein the at least one spring shackle is formed as a loop-shaped section of the spring clip.

13. Disc brake according to Claim 1,
wherein the spring arrangement has a spring back which bears resiliently against a side of the mounting tongue facing away from the brake pad.

14. Disc brake according to claim 13,
wherein the spring support sections are attached to the spring back and spread out resiliently starting from the back.

15. Disc brake according to claim 1,
wherein the spring arrangement has at least one spring tongue which positions the mounting tongue in the spring arrangement in a biased state transversely to the actuation direction.

16. Disc brake according to one claim 1,
a sensor arrangement passes through the spring arrangement and the brake pad at least partially, and which is designed to determine the pad wear.

17. Disc brake according to claim 1,
wherein a support element is fixed on the mounting tongue and against which the spring arrangement is resiliently supported.

18. Disc brake according to claim 1,
wherein a filling element is provided between the spring arrangement and the mounting tongue on a side of the mounting tongue facing the brake pad.

19. Disc brake according to claim 1,
wherein the spring arrangement embraces the at least one mounting tongue in a cage-like manner, the spring arrangement having at least one fastening arm and at least one transverse clasp, with which the spring arrangement engages in a holding manner on the mounting tongue.

20. Disc brake according to claim 19,
wherein the spring arrangement has a catch claw for positioning the spring arrangement on the mounting tongue.

21. Disc brake according to claim 19,
wherein the spring arrangement has at least one clamping extension which serves for clamping the spring arrangement on the mounting tongue.

22. Brake pad arrangement for a disc brake according to claim 1, wherein the brake pad arrangement has a brake pad carrier, on which a vehicle brake pad is mounted, wherein the brake pad carrier has at least one mounting tongue, wherein the mounting tongue is receivable in at least one receiving region such that it is guided in an actuation direction, wherein a spring arrangement is mounted on the at least one mounting tongue, by means of which spring arrangement a return force due to an elastic deformation caused by a deflection of the brake pad arrangement in order to achieve a brake effect can be applied thereon,
wherein the spring arrangement has spring support sections, by means of which the spring arrangement is supported in a biased state in the receiving region, and that the spring arrangement provides a predetermined spring travel, which is dimensioned such that a movement of the brake pad carrier for actuating the brake is permitted without brake pad wear compensation and such that when using up the predetermined spring travel the brake pad arrangement contacts the spring arrangement for brake pad wear compensation and moves the spring arrangement within the guide in order to compensate brake pad wear.
